(19) United States
(12) Patent Application Publication
(10) Pub. No.: US 2012/0025647 A1
(43) Pub. Date: Feb. 2, 2012

(54) SPINDLE MOTOR

(75) Inventors: Young Sun Yoo, Gyunggi-do (KR); Ho Jun Yoo, Gyunggi-do (KR); Jun Kyu Park, Seoul (KR)

(73) Assignee: SAMSUNG ELECTRO-MECHANICS CO., LTD., Gyunggi-do (KR)

(21) Appl. No.: 12/975,231

(22) Filed: Dec. 21, 2010

(30) Foreign Application Priority Data
Jul. 30, 2010 (KR) 1020100073929

(51) Int. Cl. H02K 5/167

(52) U.S. Cl. 310/90

(57) ABSTRACT

Disclosed herein is a spindle motor. The spindle motor includes a rotor and a stator. The rotor includes a rotating shaft and a rotor casing which is provided with a magnet. The stator rotatably supports the rotor. The stator includes an armature facing the magnet. When the rotor casing rotates at a low speed, the rotating shaft rotates in a state of being inclined at a predetermined angle with respect to the vertical direction in which the rotating shaft is upright on the stator. Therefore, because the rotating shaft rotates in the state of being inclined with respect to the stator, the rotor can uniformly rotate. If the spindle motor is used in an optical disk apparatus for forming a label surface on an optical disk, the quality of the image on the label surface of the optical disk can be enhanced.

### CROSS REFERENCE TO RELATED APPLICATIONS

This application claims the benefit of Korean Patent Application No. 10-2010-0073929, filed Jul. 30, 2010, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, in spindle motors, when a rotating shaft rotates there is a predetermined contact area between a bearing and the rotating shaft, which ensures a high level of rotational characteristics. Because of these characteristics, spindle motors are widely used as drive units of recording media, such as hard disk drives, optical disk drives (ODD), etc., which need high speed rotation.

However, in such a conventional spindle motor, when it rotates at a low speed, a rotor casing may not uniformly rotate due to the clearance between the bearing and the rotating shaft.

Hereinafter, the problem of the spindle motor using the conventional technique will be described with reference to FIG. 1 which is a sectional view showing a conventional spindle motor 100. As shown in FIG. 1, the spindle motor 100 includes a rotor 110 and a stator 120. The rotor 110 includes a clamp 111, a rotor casing 112, a magnet 113 and a rotating shaft 114. The stator 120 includes a coil 121, a core 122, a bearing 123, a bearing holder 124, a stopper 125, a thrust 126, a support 127, a PCB (printed circuit board) 128 and a base plate 129.

In detail, in the rotor 110, the rotating shaft 114 is rotatably supported by the bearing 123 of the stator 120.

The rotor casing 112 is fastened to an end of the rotating shaft 114. The magnet 113 is attached to an inner surface of the rotor casing 112 at a position corresponding to an armature including the coil 121 and the core 122. The clamp 111 elastically supports a recording medium placed on the rotor casing 112.

In the stator 120, the bearing 123 supports the rotating shaft 114 so as to be rotatable. The bearing 123 is fastened in the bearing holder 124 such that the bearing 123 is coaxial with the rotating shaft 114.

The bearing holder 124 supports the bearing 123 inserted thereinto. The armature is fitted over the bearing holder 124 around the rotating shaft 114. The armature includes the core 122 and the coil 121 which is wound around the core 122 so that external power is applied to the coil 121, electromagnetic force is generated by interaction between the coil 121 and the magnet 113. The stopper 125 is provided below the bearing 123 to prevent the rotating shaft 114 inserted into the bearing 123 from being removed from the stator 120, for example, by the rotational force of the rotor 110.

The thrust 126 prevents the rotating shaft 114 from coming into direct contact with the support 127 when the rotating shaft 114 rotates, thus preventing abrasion. The support 127 functions to support the rotating shaft 114, the stopper 125 and the thrust 126.

The PCB 128 is mounted on the base plate 129 and supplies external power to the armature. The bearing holder 124 is also mounted to the base plate 129 upright.

In the conventional spindle motor having the above-mentioned construction, when electric current is applied to the armature 121 and 122, the rotating shaft 114 and the rotor casing 112 are integrally rotated by electromagnetic force generated between the armature and the magnet 113.

However, when the rotor casing 112 rotates at a low speed, the rotating shaft 114 cannot uniformly rotate attributable to a clearance between the bearing 123 and the rotating shaft 114. In other words, the rotating shaft 114 unevenly collides with the inner surface of the bearing 123, thus making the rotation of the rotor casing 112 unstable. Furthermore, if the spindle motor is used in an optical disk apparatus which can form an image on a rear surface (a label surface) of an optical disk using a laser beam, the quality of the image formed on the label surface of the optical disk may deteriorate.

### SUMMARY OF THE INVENTION

The present invention has been made in an effort to provide a spindle motor which is configured such that when a rotor casing rotates at a low speed, it rotates in a state of being inclined with respect to a stator, thus making uniform rotation of the rotor possible, so that if the spindle motor is used in an optical disk apparatus for forming a label surface on an optical disk, the quality of an image of the label surface of the optical disk can be enhanced.

In a spindle motor according to an embodiment of the present invention, a rotor includes a rotor casing provided with a magnet, and a rotating shaft. A stator rotatably supports the rotor. The stator includes an armature facing the magnet. When the rotor casing rotates at a low speed, the rotating shaft rotates in a state of being inclined at a predetermined angle with respect to a vertical direction in which the rotating shaft is upright on the stator.

The rotor casing may rotate at low speed, the angle at which the rotating shaft is inclined with respect to the vertical direction ranges from 1° to 15°.

The stator may further include a thrust supporting a lower end of the rotating shaft. The thrust is inclined at a predetermined angle from one side to an opposite side thereof with respect to a circumferential direction of the rotating shaft.

The angle at which the thrust is inclined may range from 1° to 15°.

The stator may include a bearing rotatably supporting the rotating shaft. The bearing may be inserted into a bearing holder so that the bearing is supported by the bearing holder. The bearing holder may have the armature generating an electromagnetic force with the magnet. The bearing holder may be installed upright on a base plate. A printed circuit board may be mounted to the base plate. The printed circuit board may supply external power to the armature.

The stator may further include a stopper provided below a lower end of the bearing. The stopper may prevent the rotating shaft inserted into the bearing from being removed from the bearing by rotational force of the rotor. A support may support the rotating shaft. A thrust may prevent the rotating shaft from coming into direct contact with the support when the rotating shaft rotates, thus preventing abrasion between the rotating shaft and the support. The thrust may be inclined at a predetermined angle from one side to an opposite side thereof with respect to a circumferential direction of the rotating shaft.

The rotor may include the rotating shaft rotatably supported by the stator. The rotor casing may be fastened to an upper end of the rotating shaft. The magnet may be attached to an inner surface of the rotor casing at a position corresponding to the armature. A clamp may elastically support a recording medium placed on the rotor casing.

In a spindle motor according to another embodiment of the present invention, a rotor includes a rotor casing provided with a magnet, and a rotating shaft. A stator includes a bearing rotatably supporting the rotating shaft so that the rotor casing is rotatably supported by the stator. An armature faces the magnet. The rotating shaft rotates in a state of being inclined with respect to a vertical direction in which the rotating shaft is upright on the stator. The bearing is inclined corresponding to the inclined rotating shaft.

The rotating shaft and the bearing may be inclined with respect to the vertical direction at an angle ranging from 1° to 15°.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a conventional spindle motor;

FIG. 2 is a sectional view of a spindle motor, according to a first embodiment of the present invention; and

FIG. 3 is a sectional view of a spindle motor, according to a second embodiment of the present invention.

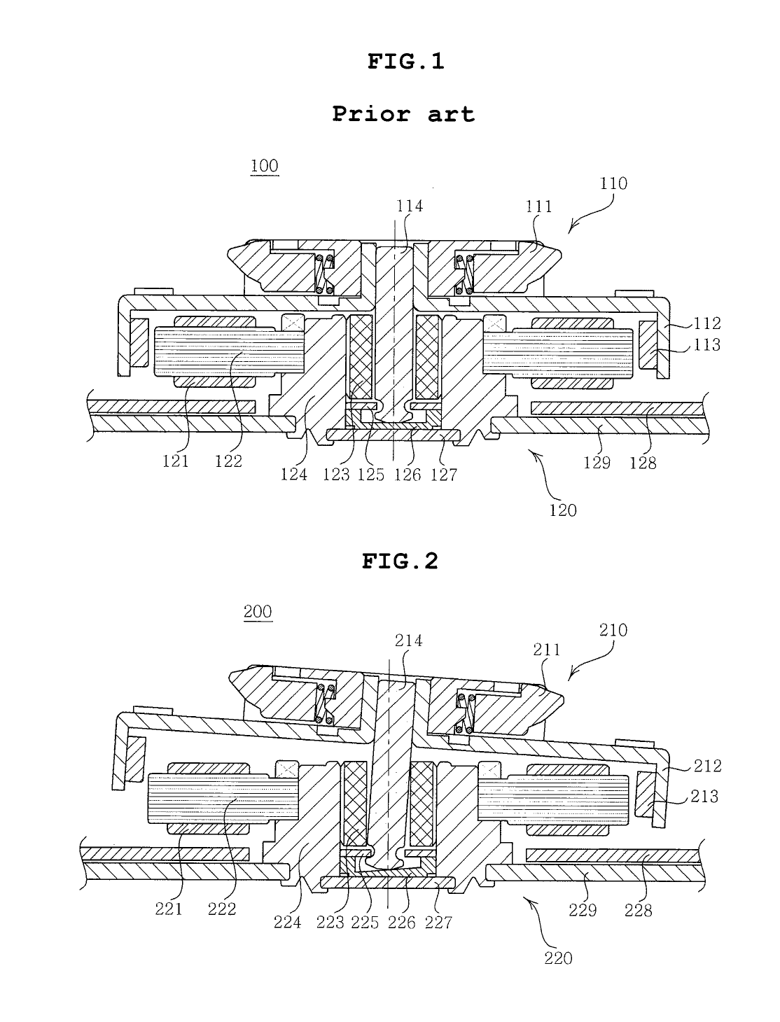

### DESCRIPTION OF THE PREFERRED EMBODIMENTS

Reference now should be made to the drawings, in which the same reference numerals are used throughout the different drawings to designate the same or similar components. In the following description, when it is determined that the detailed description of the conventional function and conventional structure would confuse the gist of the present invention, such a description may be omitted. Furthermore, the terms and words used in the specification and claims are not necessarily limited to typical or dictionary meanings, but must be understood to indicate concepts selected by the inventor as the best method of illustrating the present invention, and must be interpreted as having had their meanings and concepts adapted to the scope and sprit of the present invention so that the technology of the present invention could be better understood.

Hereinafter, embodiments of a spindle motor according to the present invention will be described in detail with reference to the attached drawings.

FIG. 2 is a sectional view of a spindle motor 200, according to a first embodiment of the present invention. As shown in FIG. 2, the spindle motor 200 includes a rotor 210 and a stator 220. The rotor 210 includes a clamp 211, a rotor casing 212, a magnet 213 and a rotating shaft 214. The stator 220 includes a coil 221, a core 222, a bearing 223, a bearing holder 224, a stopper 225, a thrust 226, a support 227, a PCB 228 and a base plate 229.

In detail, in the rotor 210, the rotating shaft 214 is rotatably supported by the bearing 223 of the stator 220.

The rotor casing 212 is fastened to an end of the rotating shaft 214. The magnet 213 is attached to an inner surface of the rotor casing 212 at a position corresponding to an armature including the coil 221 and the core 222.

The clamp 211 elastically supports a recording medium placed on the rotor casing 212.

In the stator 220, the bearing 223 supports the rotating shaft 214 so as to be rotatable. The bearing 223 is made of metal and has a cylindrical shape. In addition, the bearing 223 is fastened in the bearing holder 224 such that the axis of the bearing 223 corresponds to that of the rotating shaft 214.

The bearing holder 224 supports the bearing 223 inserted thereinto. The armature is fitted over the bearing holder 224 around the rotating shaft 214. The armature includes the core 222 and the coil 221 which is wound around the core 222 so that external power is applied to the coil 221, electromagnetic force is generated by interaction between the coil 221 and the magnet 213.

The stopper 225 is provided below the bearing 223 to prevent the rotating shaft 214 inserted into the bearing 223 from being removed from the stator 220, for example, by the rotational force of the rotor 210.

The thrust 226 prevents the rotating shaft 214 from coming into direct contact with the support 227 when the rotating shaft 214 rotates, thus preventing abrasion.

The support 227 functions to support the rotating shaft 214, the stopper 225 and the thrust 226.

The PCB 228 is mounted on the base plate 229 and supplies external power to the armature. The bearing holder 224 is also mounted in an upright position to the base plate 229.

In the present invention having the above-mentioned construction, when electric current is applied to the armature 221 and 222, the rotating shaft 214 and the rotor casing 212 are integrally rotated by electromagnetic force generated between the armature and the magnet 213.

Furthermore, in the first embodiment of the present invention, the thrust 226 is inclined from one side to the opposite side thereof with respect to the circumferential direction of the rotating shaft 214. Thus, when the rotor casing 212 rotates at low speed, the rotating shaft 214 rotates in a state where it is inclined at a predetermined angle with respect to the bearing 223, in other words, with respect to the vertical direction in which the rotating shaft 214 is upright to the stator 220. In the embodiment, the inclined angle of the rotating shaft 214 ranges from 1° to 15°. For this, the thrust 226 is also inclined at an angle ranging from 1° to 15°. Thanks to this structure, even when the rotor casing 212 rotates at low speed, the rotating shaft 214 can rotate uniformly without wobbling attributable to clearance between it and the bearing 223.

Moreover, when the rotor casing 212 rotates at a high speed, the rotor 210 is returned into the upright state by the rotational force.

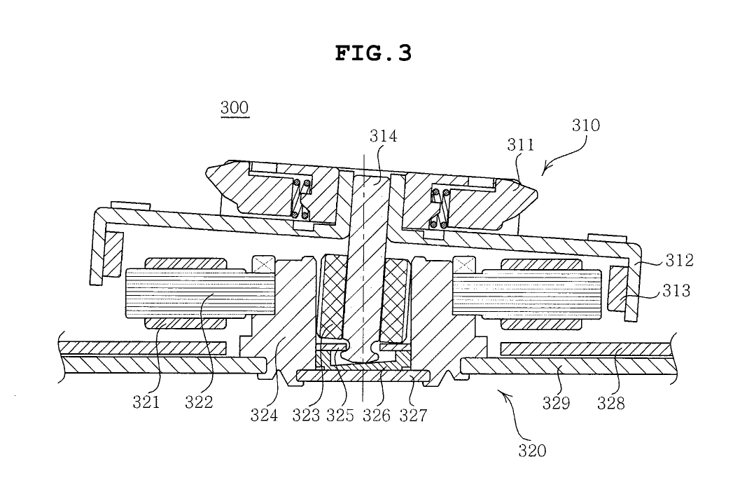

FIG. 3 is a sectional view of a spindle motor 300, according to a second embodiment of the present invention. As shown in FIG. 3, the spindle motor 300 includes a rotor 310 and a stator 320. The rotor 310 includes a clamp 311, a rotor casing 312, a magnet 313 and a rotating shaft 314. The stator 320 includes a coil 321, a core 322, a bearing 323, a bearing holder 324, a stopper 325, a thrust 326, a support 327, a PCB 328 and a base 329.

The general construction of the spindle motor 300 according to the second embodiment, excluding the bearing 323, remains the same as that of the spindle motor 200 according to the first embodiment. In the second embodiment, the bearing 323 is installed in the bearing holder 324 so as to be inclinable along with the rotating shaft 314. The rotating shaft 314 and the bearing 323 are inclined at an angle ranging from 1° to 15° with respect to the vertical direction in which they are upright to the stator 320. Thanks to this structure, even when the rotor casing 312 rotates at low speed, the rotating shaft 314 can rotate uniformly without arbitrarily rotating attributable to clearance between it and the bearing 323.

As described above, in a spindle motor according to the present invention, when a rotor casing rotates at low speed, it rotates in a state of being inclined with respect to a stator, thus making uniform rotation of the rotor possible. If the spindle motor is used in an optical disk apparatus for forming a label surface on an optical disk, the quality of the image of the label surface of the optical disk can be enhanced.

Although the embodiments of the present invention have been disclosed for illustrative purposes, it will be appreciated that the spindle motor according to the invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A spindle motor, comprising:
a rotor comprising: a rotor casing provided with a magnet; and a rotating shaft; and
a stator rotatably supporting the rotor, the stator comprising an armature facing the magnet,
wherein when the rotor casing rotates at a low speed, the rotating shaft rotates in a state of being inclined at a predetermined angle with respect to a vertical direction in which the rotating shaft is upright on the stator.

2. The spindle motor as set forth in claim 1, wherein when the rotor casing rotates at low speed, the angle at which the rotating shaft is inclined with respect to the vertical direction ranges from 1° to 15°.

3. The spindle motor as set forth in claim 1, wherein the stator further comprises a thrust supporting a lower end of the rotating shaft, the thrust inclined at a predetermined angle from one side to an opposite side thereof with respect to a circumferential direction of the rotating shaft.

4. The spindle motor as set forth in claim 3, wherein the angle at which the thrust is inclined ranges from 1° to 15°.

5. The spindle motor as set forth in claim 1, wherein the stator comprises:
a bearing rotatably supporting the rotating shaft;
a bearing holder into which the bearing is inserted so that the bearing is supported by the bearing holder, the bearing holder having the armature generating an electromagnetic force with the magnet;
a base plate on which the bearing holder is installed upright; and
a printed circuit board mounted to the base plate, the printed circuit board supplying external power to the armature.

6. The spindle motor as set forth in claim 5, wherein the stator further comprises:
a stopper provided below a lower end of the bearing, the stopper preventing the rotating shaft inserted into the bearing from being removed from the bearing by rotational force of the rotor;
a support supporting the rotating shaft; and
a thrust preventing the rotating shaft from coming into direct contact with the support when the rotating shaft rotates, thus preventing abrasion between the rotating shaft and the support,
the thrust being inclined at a predetermined angle from one side to an opposite side thereof with respect to a circumferential direction of the rotating shaft.

7. The spindle motor as set forth in claim 1, wherein the rotor comprises:
the rotating shaft rotatably supported by the stator;
the rotor casing fastened to an upper end of the rotating shaft, with the magnet attached to an inner surface of the rotor casing at a position corresponding to the armature; and
a clamp elastically supporting a recording medium placed on the rotor casing.

8. A spindle motor, comprising:
a rotor comprising: a rotor casing provided with a magnet; and a rotating shaft; and
a stator comprising: a bearing rotatably supporting the rotating shaft so that the rotor casing is rotatably supported by the stator; and an armature facing the magnet,
wherein the rotating shaft rotates in a state of being inclined with respect to a vertical direction in which the rotating shaft is upright on the stator, and the bearing is inclined corresponding to the inclined rotating shaft.

9. The spindle motor as set forth in claim 8, wherein the rotating shaft and the bearing is inclined with respect to the vertical direction at an angle ranging from 1° to 15°.
